(19) United States
(12) Patent Application Publication
(10) Pub. No.: US 2017/0076059 A1
(43) Pub. Date: Mar. 16, 2017

(54) DETECTION AND NOTIFICATION OF PRESCRIPTION NON-ADHERENCE

(71) Applicant: Experian Health, Inc., Franklin, TN (US)

(72) Inventor: Hans P. Morefield, Katonah, NY (US)

(73) Assignee: Experian Health, Inc., Franklin, TN (US)

(21) Appl. No.: 15/081,494

(22) Filed: Mar. 25, 2016

Related U.S. Application Data
(60) Provisional application No. 62/217,140, filed on Sep. 11, 2015.

(51) Int. Cl. G06F 19/00

(52) U.S. Cl. CPC G06F 19/3456; G06F 19/322; G06F 19/325; G06F 19/3431; G06F 19/326

(57) ABSTRACT

Improving prescription adherence for discharged patients is of growing importance for healthcare providers, accountable care organizations, and insurance providers. Patients have several reasons for deviating from a course of treatment or falsifying data to indicate that they are following a course of treatment. By removing the patient from the reporting chain, the risk of falsified data is reduced, and healthcare providers can intervene and adapt treatments to account for non-adherence to a course of treatment. Existing electronic medical record systems and methods, however, are cumbersome and do not allow for adherence information to be reliably collected and presented to healthcare providers to use in the ongoing or future treatment of a patient.

### RELATED APPLICATIONS

This application claims priority from U.S. Provisional Patent Application No. 62/217,140 titled, “PRESCRIPTION ADHERENCE” and having a filing date of Sep. 11, 2015, which is incorporated herein by reference.

### BACKGROUND

Healthcare providers have a vested professional interest in their patients following through with prescribed courses of treatment. As part of a prescribed course of treatment, patients may be prescribed various medications, which they are expected to administer themselves or with the help of a family member or home healthcare professional. Many patients, however, do not follow through on administering prescribed medications outside of a healthcare provider's facilities, and therefore increase the risk of readmission and the risk of viruses and microorganisms (e.g., bacteria, worms, fungi) developing resistance to existing drugs. The number of patients who do not following through with a course of treatment is significant; the Centers for Disease Control (CDC) state that that 20-30% of prescriptions go unfilled and are not continued as prescribed in at least 50% of cases. Patients may forego continuing a course of medications as prescribed due to cost concerns for filling prescriptions, forgetfulness, fear of side effects, and various other reasons, but the end result is an increased risk to the patient's health and increased costs for healthcare providers and payors.

Additionally, for reasons of interoperability between healthcare providers and government-provided incentives, many healthcare providers have switched from paper records to Electronic Medical Records (also known as Electronic Health Records). To ease the transfers of patients and records between healthcare providers, healthcare providers use a standard set of documents having standardized formats, known as the Clinical Document Architecture (CDA). The use of electronic documents managed under a standard, however, has led to the problem that new document types cannot be created as needed by one healthcare provider and electronically interpreted by another healthcare provider.

Although healthcare providers can set internal reminders to urge patients to follow through and may periodically ask patients to self-report adherence rates, healthcare providers are ultimately reliant on the patient's dedication to self-administration and self-reporting of adherence to a prescribed course of treatment to ensure that the patient is properly treated after discharge.

### BRIEF SUMMARY

Systems and methods for the improved detection of patient adherence with a course of prescribed medication are provided herein. Patients who are at risk for noncompliance with their healthcare provider's course of treatment may be identified and appropriate actions may be taken as a result. Similarly, healthcare providers whose patients have lower rates of compliance and medications that have lower rates of compliance may also be identified and appropriate action may be taken as a result. Electronic document systems are thereby improved to work with current systems and provide additional information in a digestible form without forcing other healthcare providers to update their electronic document systems.

Rather than relying on patients to self-report adherence to a course of treatment via a follow-up visit, phone call, or check-in system (e.g., a patient portal or mobile application), at-risk patients, providers, and medications are identified automatically. Electronic Medical Records (EMR) are examined to determine a course of treatment, and when a course of treatment of interest is identified, the fill history for the associated prescription is queried. The prescribed medication from the course of treatment is compared with the fill history to determine whether the patient filled the prescription. The result of the comparison is stored, and if the result indicates that the patient has not properly filled the prescription, then a care manager or physician can be alerted to intervene. Over time, histories for prescription follow-through for each patient, provider, and medication are assembled and healthcare providers can use this information to adapt treatments in the future and intervene in the patient's current treatment.

### BRIEF DESCRIPTION OF THE DRAWINGS

The accompanying drawings, which are incorporated in and constitute a part of this disclosure, illustrate various aspects and examples of systems and methods for the improved detection of patient compliance with a course of prescribed medication. In the drawings:

FIG. 1 is a block diagram illustrating example components in a non-adherence detection system;

FIGS. 2A and 2B illustrate example layouts of Hospital Discharge Medication Sections of a Continuity of Care Document architecture;

FIG. 3 is a flow chart showing general stages involved in an example method for identifying non-adherence to a prescribed course of medication; and

FIG. 4 is a block diagram illustrating physical components of an example computing device with which aspects of the present disclosure may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. Examples may take the form of a hardware implementation, or an entirely software implementation, or an implementation combining software and hardware aspects. The following detailed description is, therefore, not to be taken in a limiting sense.

Systems and methods for the improved detection of patient adherence with a course of prescribed medication are provided herein. Patients who are at risk for noncompliance with their healthcare provider's course of treatment may be identified and appropriate actions may be taken as a result. Similarly, healthcare providers whose patients have lower rates of compliance and medications that have lower rates of compliance may also be identified and appropriate action may be taken as a result. Electronic document systems are thereby improved to work with current systems and provide additional information in a digestible form without forcing other healthcare providers to update their electronic document systems.

Rather than relying on patients to self-report adherence to a course of treatment via a follow-up visit, phone call, or check-in system (e.g., a patient portal or mobile application), at-risk patients, providers, and medications are identified automatically. Electronic Medical Records (EMR) are examined to determine a course of treatment, and when a course of treatment of interest is identified, the fill history for the associated prescription is queried for. The prescribed medication from the course of treatment is compared with the fill history to determine whether the patient filled the prescription. Over time, histories for prescription follow-through for each patient, provider, and medication are assembled and healthcare providers can use this information to adapt treatments in the future and intervene in the patient's current treatment.

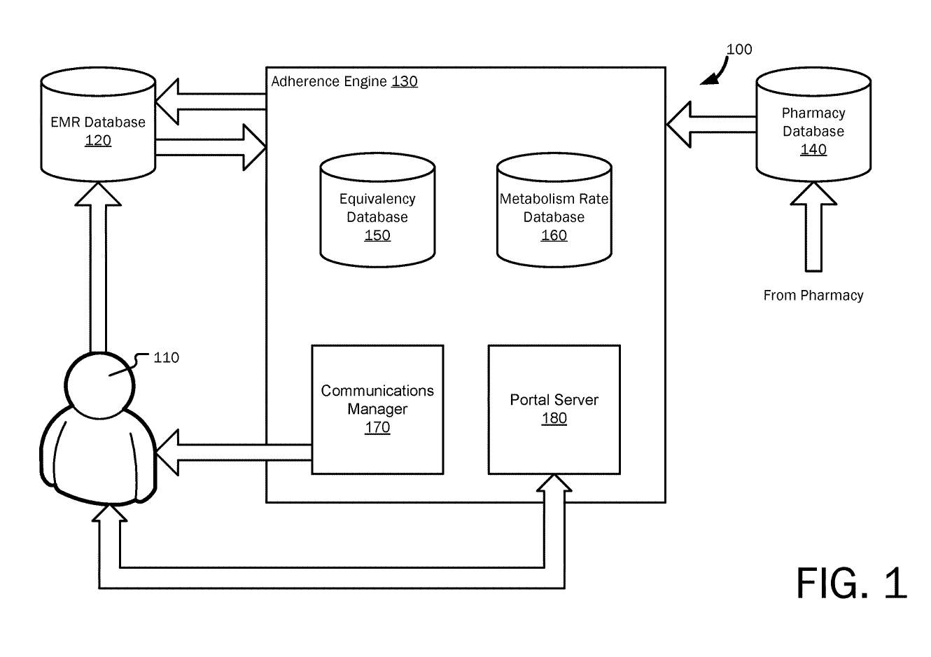

FIG. 1 is a block diagram illustrating example components in a non-adherence detection system 100. The system 100 compares the medications prescribed at the time of discharge from a healthcare provider to those actually provided to a discharged patient by a pharmacy to automatically determine whether the patient is following a prescribed course of treatment. Because one of the leading causes for patients not following a course of treatment is patients deciding not to fill a prescription properly (often to save money), the filling of a prescription is used herein as a more reliable indicator of patients' adherence than asking patients to self-report their adherence. Patients have been known to cut pills in half and take reduced dosages to “extend” their supply of medication to reduce their costs while still reporting that they are taking the medication as prescribed. Therefore, knowing whether the patients have paid for and collected the medication as prescribed may be used as a reliable stand-in or supplemental data for patient adherence without requiring the patient to input any data, reliable or otherwise.

When a patient is discharged by a healthcare provider, a healthcare professional 110 (e.g., an employee or agent of the healthcare provider such as a physician, nurse, administrator, assistant, or automated system) will generate a Continuity of Care Document (CCD) outlining the information needed for the continued care of the patient as the patient moves from one care setting to another. As will be understood, the CCD can be generated automatically along with the EMR at the time of discharge or as a separate document. According to an aspect, a CCD is an electronic document formatted according to a suitable structuring language, such as the Extensible Markup Language (XML), structured according to the Clinical Document Architecture (CDA) standard. While the CCD may be described herein as an XML-structured document, any suitable structuring language may be used for tagging or otherwise identifying portions of the document associated with particular types of data. The CCD includes information related to one or more healthcare encounters, but is not meant as a comprehensive medical file on the patient. Instead, the CCD includes the most relevant information for the continued care of a patient once the patient has been discharged from a healthcare facility, which includes transfers to other healthcare facilities and release of the patient. Such relevant information includes, but it not limited to: patient name, sex, date of birth, race, ethnicity, preferred language, smoking status, problems, treating professionals, medications, medication allergies, laboratory tests, laboratory values/results, vital signs, encounter diagnoses, immunizations, referral reasons, and discharge instructions. Although the term “CCD” refers to a specific document under the HL7 CDA format, one of skill in the art will appreciate that document formats change and that the term “CCD” as used herein applies to the equivalent documents defined under other standards that include prescription information for discharged patients, such as, for example, a prescription information call under the Fast Healthcare Interoperability Resources (FHIR) Standard or other documents under the HL7 CDA format that include prescription information.

In various aspects, the CCD is submitted to an Electronic Medical Record (EMR) database 120 or submitted internally (i.e., generated) within the EMR database 120 when the EMR database 120 is part of a healthcare provider's EMR system, where it may be retrieved by the adherence engine 130. In some aspects, the CCD may be retrieved in response to the adherence engine 130 receiving an Admission/Discharge/Transfer (ADT) document. In other aspects, the CCD is submitted to or generated in an EMR database 120, where it is pushed to the adherence engine 130 on submittal. In yet other aspects, the CCD is both submitted to or generated in an EMR database 120 and transmitted directly to the adherence engine 130 without the adherence engine 130 pulling the CCD from the EMR database 120 or having the CCD pushed to the adherence engine 130. The EMR database 120 may be maintained by an individual healthcare provider or as part of a Healthcare Information Exchange (HIE) managed by a Regional Health Information Organization (RHIO), governmental agency, or other provider of a shared EMR system used by multiple healthcare providers. The prescription information may also be sent to a pharmacy of the patient's choice (e.g., via an electronic prescription system) so that any prescriptions contained by the CCD can be readied in anticipation of the patient filling them.

As will be understood, the entire CCD may be sent to the adherence engine 130 or only the portions of the CCD related to the care of the patient outside of the discharging healthcare provider's facility may be extracted and sent to the adherence engine 130 (e.g., patient name, medications, encounter diagnoses, discharge instructions). When the entire CCD is sent to the adherence engine 130, the adherence engine 130 is operable to extract such information from the CCD. One of skill in the art will understand that an XML document (or other suitable structured document), such as a CCD, may include tags or other similar markers that encapsulate different sections of the document and a document may have its information extracted based on the tags.

The EMR database 120 is operable to store the treatment histories and personal and demographic data for several patients of a healthcare provider. In some aspects, the histories and data are related to the one healthcare provider that manages the EMR database 120, while in other aspects, an EMR database 120 may include histories and data from several healthcare providers. For example, a hospital may manage an EMR database 120 to build profiles of each of its patients including their treatment histories at the hospital, and information related to procurement of medical services (e.g., insurance provider, emergency contact information, consent forms). The information used to build the EMR database 120 may be taken solely from the hospital or may include information from external sources, such as, for example, a family practitioner that has transmitted its records on a given patient to the hospital to aid the hospital in treating the patient. Similarly, records may be transferred from the EMR database 120 to an external source to supplement the external source's records to aid in treating a patient. As will be understood, the transfer of medical records is subject to several privacy laws, which one of skill in the art would be familiar with and would follow when transferring such medical records.

The adherence engine 130 is operable to use the information from the CCD to determine whether the patient has been discharged with an ongoing condition that includes prescribed medications of interest. As will be understood, not all patients are discharged with prescriptions and not all prescriptions are of interest to a healthcare provider for ensuring that the patient takes according to a course of treatment. For example, a patient may be discharged from a hospital for a broken arm with no prescription (including being recommend an over-the-counter medication) or with a prescription for a pain killer to be taken “as needed,” which a healthcare provider may not be interested in ensuring the patient takes as part of follow-up care. In contrast, a patient may be discharged from a hospital for pneumonia with a strict regimen of antibiotics that the healthcare provider is interested in ensuring the patient takes on a particular schedule. Similarly, a patient may be discharged with multiple medications prescribed, of which none, one, or several medications may be of interest.

A healthcare provider making use of the adherence engine 130 may define a medication to be of interest via a database containing the names of the medications and criteria to set when a named medication is of interest. Medications may be associated with criteria indicating that they are of interest when the criteria are met, but not of interest when the criteria are not met. Example criteria include, but are not limited to: age of the patient, insurance policy of the patient, income of the patient, party the patient is discharged to (e.g., self-care, parental/family care, hospice care, a different healthcare provider), number of refills of the prescription available to the patient, the expected duration of care of the patient related to the medication, dosage of the medication, class of the medication (e.g., painkiller, anti-coagulant, antibiotic, hormone therapy), name of the medication, method of administration (e.g., oral pill, suppository, injection, oral liquid, topical ointment, patch, implant), previous adherence history for the patient, previous adherence history for the prescribing healthcare professional 110, previous adherence history for the medication, and combinations thereof.

Each of the criteria may be evaluated separately in a combined analysis of whether the medication is of interest, such that if any one of the criteria meet a threshold for interest, the medication will be determined to be of interest, or each of the criteria may be evaluated together, such that criteria may influence one another such that an aggregate interest is determined. For example, if the class of medication is evaluated separately, the medication may be determined to be of interest regardless of any other criterion. In another example, if the age of the patient and the party discharged to are evaluated together, a ninety-year-old patient's prescription for heart medication may be deemed of interest unless the patient is discharged into the care of another healthcare provider (a different hospital, a nursing home, etc.). As will be understood, the criteria that are evaluated together may be weighted differently in the evaluation, and a given criterion having a first weight in a first evaluation may be given a second weight in a second evaluation.

Once the adherence engine 130 has determined a medication is of interest for the ongoing treatment of the patient, a pharmacy database 140 is queried for fill information related to the prescription for the medication of interest. In an alternative aspect, instead of querying pharmacy database 140, a pharmacy may transmit fill information directly to the adherence engine 130 when it fills a prescription for the medication. The fill information may include, but is not limited to: date of filling, location of filling, whether insurance was accepted, whether a discount was applied, patient name, medication name, amount of medication supplied, administration means supplied (e.g., liquid, gel-caps, pills, aerosol), dosage of medication supplied (e.g., 30 mg administration means, 15 mg administration means), and amount of medication yet to be filled.

The pharmacy database 140 may be internally or externally managed by the healthcare provider and the adherence engine 130 may be in communication with multiple pharmacy databases 140. For example, the pharmacy database 140 may be provided by an individual pharmacy store, a conglomeration of pharmacy stores (e.g., centrally provided by a corporation having multiple pharmacy stores), or a third-party pharmacy monitor. Similarly, if the healthcare provider is affiliated with a dispensary or pharmacy, the pharmacy database 140 may be managed internally by the healthcare provider.

When the adherence engine 130 has access to both the prescription information and the filling information, the prescribed medication is compared with the medication that was filled to determine whether the patient is adhering to the course of treatment outlined in the CCD. For example, a patient who was prescribed a 45 mg dose of medication to be taken twice a day for thirty days who does not fill the prescription, does not fully fill the prescription, or has the prescription improperly filled will be determined to not have properly filled the prescription.

As will be understood, many medications may be prescribed under several trade or chemical names that may be substituted by a pharmacy without deviating from the patient's course of treatment. For example, the CCD may indicate that nitroglycerin is prescribed for the patient, but the pharmacy may indicate that glyceryl trinitrate has been filled for the patient; these are different names for the same compound. Similarly, several medications have generic and/or biosimilar versions available that may be substituted freely without causing the patient to deviate from the course of treatment. For example, fluoxetine is the generic medication of the brand name medication Prozac® offered by ELI LILLY & CO. CORPORATION of Indianapolis, Ind. The adherence engine 130, therefore, is operable to consult an equivalency database 150 that includes listings of equivalent compounds to determine whether the medication indicated by the CCD is equivalent in its active formulation to that filled by the pharmacy.

As will also be understood, medications may be provided in different dosages, which may or may not induce a patient to deviate from a course of treatment. The adherence engine 130 is therefore operable to calculate dosage equivalencies when the dosages from the CCD and the fill information do not match. For example, a CCD may indicate that 15 mg of the medication is to be taken daily, but the pharmacy indicates that the prescription was filled with 5 mg dosages at three times the quantity that would have been supplied for 15 mg doses; a patient may still take the same amount of medication and adhere to the course of treatment, albeit via a correspondingly higher number of pills/capsules. In a contrary example, if the CCD indicates that 15 mg of the medication is to be taken daily, but the pharmacy indicates that the prescription was filled with 30 mg dosages at half the quantity that would have been supplied for 15 mg doses, the patient may not be able to take the medication as filled without deviating from the course of treatment.

The adherence engine 130 therefore is operable to consult a metabolism rate database 160 when the filled dosage differs from the prescribed dosage to determine whether the patient may take the filled dosage while adhering to the prescribed course of treatment. For example, if a medication is indicated by the pharmacy to have been filled at twice the prescribed dosage (e.g., 30 mg instead of 15 mg), the adherence engine 130 may consult metabolism rates for medications, stored by the metabolism rate database 160, to determine whether the patient may take the medication at half the rate to compensate for the correspondingly higher dosage (e.g., once daily rather than twice daily). Similarly, the adherence engine 130 may determine that a lower dosage may result in deviation if the amount to administer at one time is not altered or cannot be altered to match the original prescription. For example, if the pharmacy does not indicate to take two pills of half the prescribed dosage instead of one of the original dosage or if the filled dosage is not a factor of the prescribed dosage (e.g., the filled dosage is for n mg, but the prescribed dosage is not a multiple of n mg).

The adherence engine 130 is also operable to determine whether the prescription has been filled on time. For example, the first course of prescription (i.e., the first “fill”) may be determined to have been filled on time if it is filled within a window defined by the prescribing healthcare professional 110, such as, for example, n days after discharge. Similarly, when a medication is prescribed with at least one refill, the adherence engine 130 is operable to check whether the refill was filled on time. As will be understood, medications that are prescribed with refills may be tightly scheduled or loosely scheduled for refilling. For example, a course of medication that the patient is directed to take one per day is tightly scheduled, and the adherence engine 130 may calculate a fill-by date for the on-time refill of the medication based on the date of previous fill/refill, the amount of medication provided by the pharmacy, and the amount to be taken in a given time period. A patient prescribed a loosely scheduled medication, however, may be directed to take the medication “as needed,” and an exact time that the medication is expected to be consumed cannot be calculated with the same degree of precision as a tightly scheduled medication. The adherence engine 130, therefore, is operable to calculate fill-by date for a loosely scheduled medication based on the date of previous fill/refill, the amount of medication provided by the pharmacy, and a historic consumption rate. In various aspects, the historic consumption rate may be determined for the specific patient based on previous consumption rates determined by the adherence engine 130 from records held by the EMR database 120, or from an average patient consumption rate, using the aggregated historical consumption rates of patients who have been prescribed the same medication.

In various aspects, the adherence engine 130 is operable to check whether the patient is adhering or deviating from the course of treatment according to different triggers. For example, the submission of a CCD may trigger the adherence engine to check the patient's adherence at a set time after the submission (e.g., 30 minutes after submission, eight hours after submission). In another example, the adherence engine 130 may perform its check at a given time of day (e.g., at 4 a.m., at 10 p.m.). The adherence engine 130, when checking at a given time of day, may batch all of its checks to process at the same time, or multiple given times may be specified so that only a portion of the checks are executed at one given time.

When the adherence engine 130 determines that the medication provided to the patient was a correct medication (i.e., the prescribed medication or an equivalent), at a proper dosage, filled by or before the fill-by date, the patient will be determined to be in adherence to the course of treatment for the time being. When the adherence engine 130 determines that the medication provided to the patient was not a correct medication, not at a proper dosage, not filled by the fill-by date, or combinations thereof, the patient will be determined to not be in adherence to the course of treatment. As will be understood, if a prescription includes at least one refill, a patient may be determined to be adhering or not adhering at each individual fill/refill's fill-by date.

When the adherence engine 130 determines that the patient is not adhering to the course of treatment, a healthcare provider alert is generated and provided to the healthcare provider. In various aspects, the healthcare provider alert is transmitted to a healthcare professional 110 for further review and follow-up with the patient, while in other aspects a system (e.g., an automated phone dialer) operated by the healthcare provider may receive the healthcare provider alert and automatically contact the patient. Because a course of treatment that a patient is deviating from may be corrected with fewer ill effects the sooner it is resumed, and a course of treatment resumed or begun too late may be ineffective, time is of the essence in providing the healthcare provider alert.

In various aspects, the adherence engine 130 includes a communications manager 170 by which the healthcare provider alerts are sent to designated healthcare professionals 110 associated with the patient who is found to not be in adherence. The communications manager 170, in various aspects, may include an email server connected to a network to send the healthcare provider alert as an email (e.g., via STMP, POP, or IMAP protocols), a paging server including an antenna to wirelessly send the healthcare provider alert to a healthcare professional's pager (e.g., via FLEX, POCSAG, or GOLAY protocols), or a cellular server in communication with a cellular tower to send the healthcare provider alert to a healthcare professional's cellular device as a text message (e.g., via SMS or MMS protocols). In various aspects, the communication manager 170 may transmit the healthcare provider alert or a hyperlink to access the healthcare provider alert via a portal.

The adherence engine 130 includes a portal server 180 to provide a user interface by which healthcare professionals 110 may look up healthcare provider alerts. In various aspects, emails, pages, and text messages sent by the communications manager 170 may alert the healthcare professional 110 to access the portal server 180, and may include a hyperlink to the corresponding healthcare provider alert hosted on the portal server 180. Additionally, the healthcare professional 110 may browse the portal server 180 for healthcare provider alerts related to a patient, medication, or healthcare professional 110. In some aspects, the healthcare professional 110 is presented with a summary report of the adherence of patients associated with the healthcare professional 110 as a splash screen when first accessing the portal or an EMR system in communication with the adherence engine 130. For example, when a healthcare professional 110 first logs into a computer used as an access point for the EMR system the summary report may be displayed.

The healthcare provider alert is generated by the adherence engine 130 to include deviation information related to deviations from the prescribed course of treatment. For example, a mismatch between medications or dosages between the prescription information and the filling information or a missed fill-by date would be presented as deviation information in a healthcare provider alert. In various aspects, the adherence engine 130 compares the filling information to the prescription information in the CCD field by field to determine the deviation information. To reduce processing time and to ensure that the healthcare provider alert is compatible with the EMR database 120 and other systems compliant with the CDA, the healthcare provider alert may be generated from the CCD from which the prescription information was extracted. In various aspects, the CCD is also updated with the deviation information so that the healthcare provider will have an accurate record of the medications that the patient is actually taking (or avoiding taking) in the event that the patient is readmitted by the healthcare provider or the patient schedules a subsequent appointment with the healthcare provider.

The deviation information included in the healthcare provider alert may vary based on the field found to be deviating and options set by the healthcare provider. For example, if the deviation can only be represented textually, the deviation information may alert the healthcare provider what the deviation is, and if the deviation can also be represented numerically, the extent of the deviation may be provided to the healthcare provider. For example, if the medication filled deviates from the medication prescribed, the name of the prescribed and filled medications may be indicated textually in the deviation information. However, if the dosage or amount of the medication filled deviates from the medication prescribed, the deviation information may include an extent of deviation. For example, the deviation information may indicate the dosage prescribed, the dosage filled, and a difference (e.g., 20 mg prescribed, 30 mg filled, 10 mg difference). As will be understood, when calculating a deviation in the extent of a dosage, the adherence engine 130 is operable to consult the metabolism rate database 160 and administration information (e.g., take the medication twice daily versus once daily) to determine whether an apparent deviation is an actual deviation.

In various aspects, the adherence engine 130 is further operable to update a risk assessment profile for the patient in the EMR database 120 based on the patient's adherence to the course of treatment. For example, a patient in adherence may have a risk assessment profile updated to indicate that the patient is of a lower risk to deviate from a course of treatment than other factors would otherwise indicate. Similarly, a patient not in adherence may have a risk assessment profile updated to indicate that the patient is of a higher risk to deviate from a course of treatment than other factors would otherwise indicate. Healthcare professionals 110 may access the risk assessment profile when determining a course of treatment for the patient. For example, based on the risk assessment profile of a patient, the healthcare professional 110 may determine that the patient cannot be trusted to follow through with a course of treatment alone, and may recommend a home healthcare provider to follow up with the patient, decide to prescribe a less expensive alternative medication that the patient is more likely to adhere to, etc.

A healthcare provider may also review the results of the adherence engine 130 periodically to determine whether certain healthcare professionals 110 or medications have lower or higher rates of adhering patients. The healthcare provider can then use this information to dictate training programs, identify best practices, and select courses of treatment that take into account historical adherence rates.

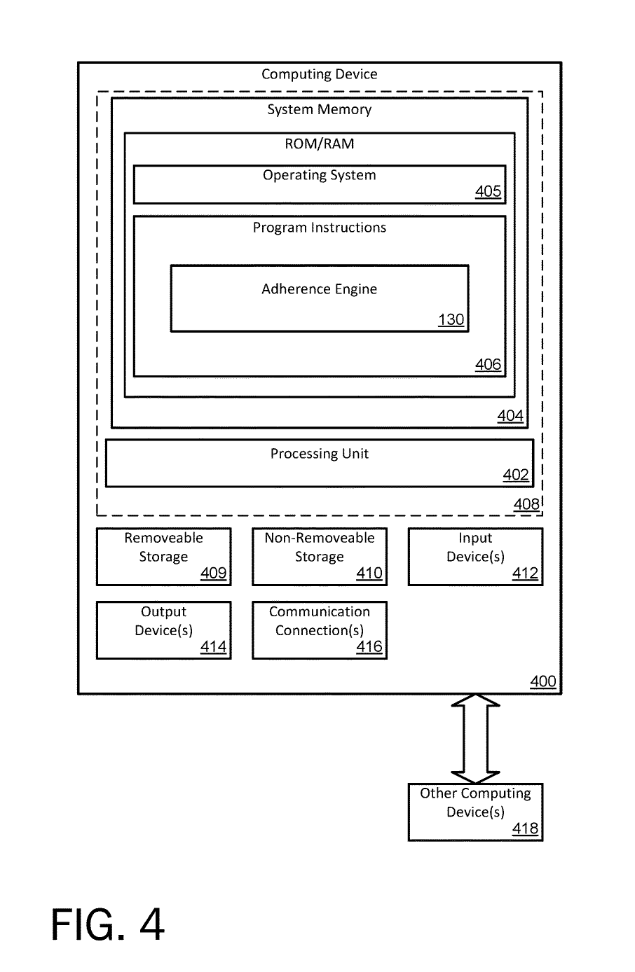

According to aspects, the adherence engine 130 is a system, device or collection of software instructions operating on a system or device operative to automatically determine patient adherence to a course of treatment. As used herein, the term “engine” represents an individual computing device having processing, memory and other computer operating components described below with reference to FIG. 4 on which is hard coded operating instructions or with which is processed a set of computer-executable instructions for causing the engine to perform the functions described for it herein. Alternatively, the term “engine” represents a set of instructions executed by a computing device or system (FIG. 4) for causing the engine to perform the functions described for it herein. The engine described above may operate independently, but communicatively, with other engines or each engine may be integrated as a single operating environment or system (e.g., the adherence engine 130, described herein).

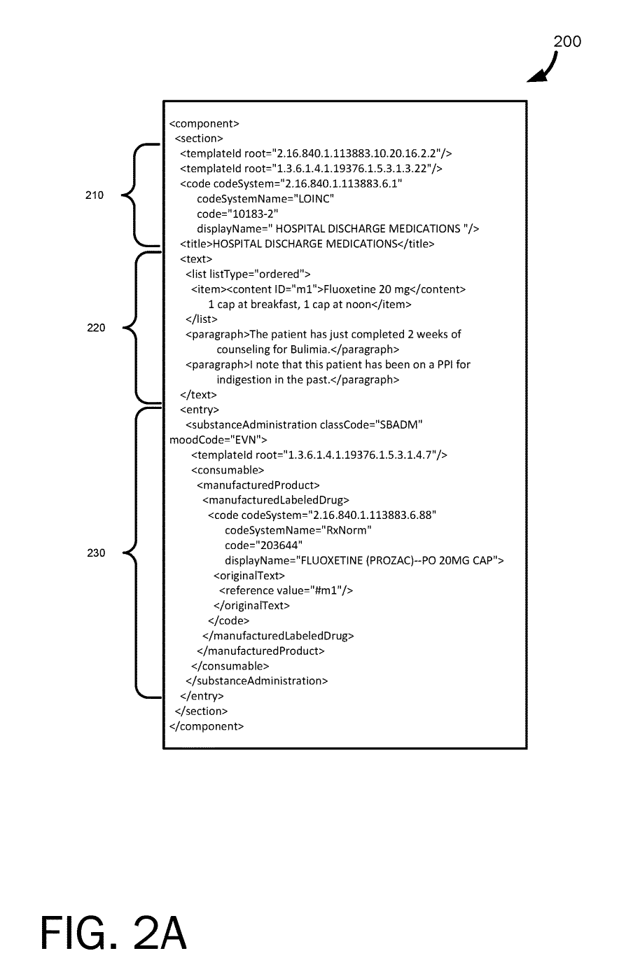

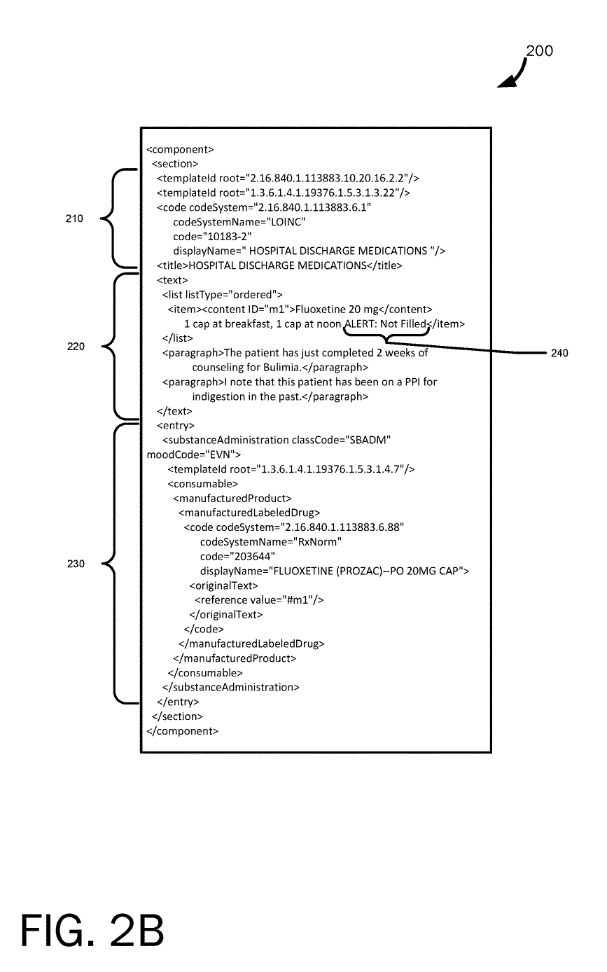

FIGS. 2A and 2B illustrate example XML layouts of Hospital Discharge Medication Sections (HDMS) 200 of a CCD architecture compliant with CDA used to improve the identification of non-adherence to a prescribed course of medication. FIG. 2A illustrates the original state of the HDMS 200 at time of discharge of the patient, and FIG. 2B illustrates the updated state of the HDMS 200 after the deviation is detected and used to update the CCD. In various aspects, the CCD in its updated state is saved to the EMR database 120 so that during future visits by the patient, treating healthcare professionals 110 may learn of the patient's non-adherence to prior courses of treatment. In other aspects, the CCD may remain un-updated and a healthcare provider alert may instead be submitted to the EMR database 120, transmitted to an email account or messaging device (e.g., pager or cellular device) of a healthcare professional 110, or presented via an internet-based portal service to healthcare professionals 110.

As will be understood, the HDMS 200 is a required section under CDA for a discharge summary report. Other required sections include Allergies, Hospital Course of Treatment, Hospital Discharge Diagnosis, and Plan of Care sections. The discharge summary report may also include optional sections, such as, but not limited to: Family History, History of Present Illness, Immunizations, Payers, Reason for Visit, and Social History sections. One of skill in the art will be able to use the present disclosure to understand that deviation information may be added to one or more sections, required or optional, and that the deviation information does not need to be added to the HDMS 200 if it is added to another section. The illustrated examples using the HDMS 200 are given as non-limiting examples of how deviation information may be added to an existing format of a report so that capable systems are provided with more information without disrupting the functionality of the report for incapable systems.

In FIG. 2A, the XML layout of an example HDMS 200 is illustrated having three major components including tagged content; the header component 210, the human readable component 220, and the coded component 230. The header component 210 includes information relevant to the interpretation of the HDMS 200 (e.g., template ID, code information, title).

The human readable component 220 of the HDMS 200 includes information related to the prescription of medications including medication name, medication dosage, medication frequency, administration means, and treatment notes. In various aspects, the human readable component 220 is demarcated by text tags or the inline equivalent (e.g., “<text> </text>”, “<text/>”). Human readable content in the human readable component 220 may be organized according to various methods and the associated tags. For example, content may be ordered in lists (ordered and unordered), paragraphs, tables, columns, rows, cells, etc.

The coded component 230 includes information related to the prescription of medications including medication name, medication dosage, and administration instructions in a machine readable format according to the information held in the header component 210. In various aspects, the coded component 220 is demarcated by entry tags or the inline equivalent (e.g., “<entry> </entry>”, “<entry/>”). The content in the coded component 230 is automatically generated based on the content entered into the human readable component 220 at the time the human readable content is finalized (e.g., the CCD is saved or submitted).

In various aspects, the EMR system of a healthcare provider may accept textual input (e.g., via a keyboard or touch screen) from a healthcare professional 110 to generate the content held by the human readable component 220, which in turn is automatically translated into the coded component 230 by the EMR system. As one of skill in the art will understand, the EMR system may look for keywords, provide spell checking, expand acronyms and abbreviations, and map known terms when translating human readable content into coded content.

The prescription information may be extracted from the HDMS 200 from either the human readable component 220 or the coded component 230 for transmission to the pharmacy and/or to the adherence engine 130. The extracted information may be used to create a healthcare provider alert in conjunction with the filling information from the pharmacy database 140 and additional information from the CCD (e.g., patient name), if a deviation from the prescription information is discovered in the filling information.

FIG. 2B illustrates the HDMS 200 after it has been updated to include the deviation information from the healthcare provider alert as an insert 240. Because the format of a CCD is strictly controlled by the CDA, so that multiple healthcare providers can read CCDs from each other despite using unique EMR systems, adding novel sections and information to a CCD may cause aberrant behavior in an EMR system that does not expect such novel sections or information. The CDA does not include a section or entry in a CCD for non-compliance with a medication, and the addition of such information must therefore be handled so that its addition does not cause errors for systems that are unaccustomed to it. For example, a first healthcare provider using an EMR system that is capable of reading deviation information may send records, including the deviation information, to a second healthcare provider that is not capable of reading deviation information, but still must be capable of interpreting the CCD.

To enable EMR systems to add the deviation information without interfering with the interpretation of the CCD in other EMR systems, how the deviation information is added differs from how the CCD was originally created. Deviation information may be added to the human readable component 220 as a new text entry or added to an existing item or text entry relevant to the deviation information. For example, for a medication, the item field may be updated with an insert 240 to state that a deviation occurred and/or the extent of the deviation. In one aspect, unlike the original creation of the CCD, however, the coded component 230 is not automatically updated to reflect the human readable component 220. Because the deviation information may include medication information (names, dosages, administrations, etc.), the automatic parsing from the human readable component 220 may result in the system parsing the wrong information, especially in EMR systems that do not expect deviation information. Therefore, the insertion of deviation information overrides the routine and conventional sequence of events ordinarily triggered by the entry of human readable content into a CCD to result in a CCD containing additional information while remaining readable by any CDA compliant EMR system. In various aspects, the insert 240 may be tagged (e.g., with “<deviation> </deviation>”, “<deviation/>” or a hyperlink to the healthcare provider alert) to identify it to compatible EMR systems as the deviation information, which other systems may treat as text.

To ensure that the deviation information is added to the proper location in the human readable component 220, the CCD is parsed to find the location of the medication information within the human readable component 220 corresponding to the medication that the patient is deviating from. When a prescribed mediation in the human readable component 220 is identified that matches the medication in the prescription information, which the patient is not adhering to according to the filling information, the deviation information is inserted within its tags. In various aspects, the deviation information may be inserted at the beginning or end of the tagged information depending on system preferences for how deviation information is to be displayed relative to original prescriptions.

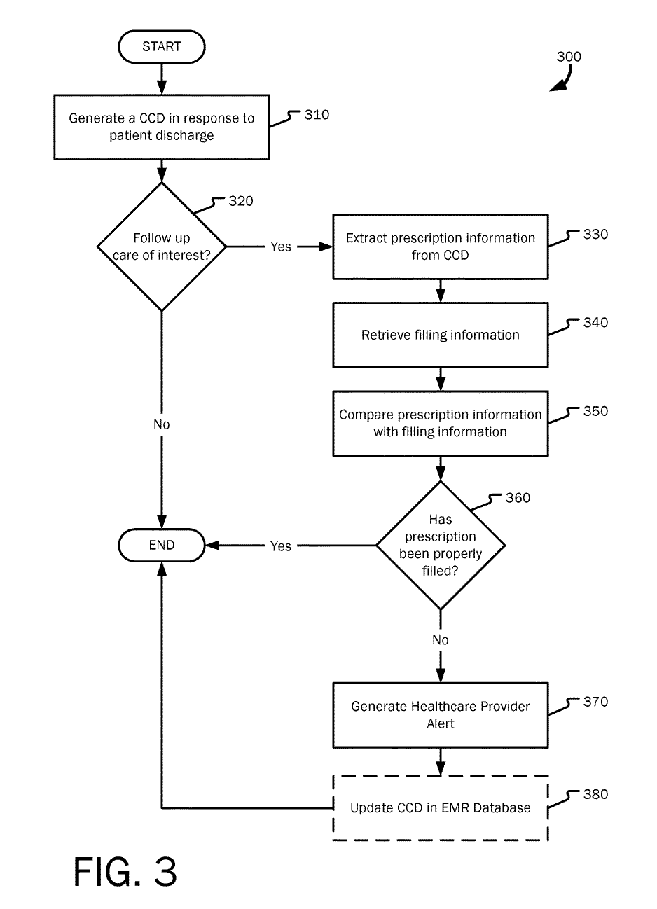

FIG. 3 is a flow chart showing general stages involved in an example method 300 for identifying non-adherence to a prescribed course of medication. Method 300 begins with OPERATION 310 when a CCD is generated in response to a patient being discharged. Patients are discharged by healthcare providers at the end of their treatment at the healthcare provider's facility, and further instructions for the patients' care, if appropriate, are included in the CCD. As should be appreciated, a discharge may include release from any interaction between the healthcare provider and the patient such as a hospital stay, office visit, house-call or any other interaction between a healthcare provider and the patient where an instruction (such as a prescription fill) is provided to the patient that may require monitoring as described herein.

Method 300 proceeds to DECISION OPERATION 320 where it is determined whether any follow-up care is of interest to the healthcare provider. Not all patients require additional care after discharge, and not all additional care includes prescriptions for medication of interest to the healthcare provider. For example, a patient discharged after the removal of a cast for a broken arm may have no further treatments scheduled related to the now-healed arm or the medication, such as, for example, a mild painkiller or muscle relaxant, may not be of interest to the healthcare provider for follow-up with the patient or to reduce the risk of readmission of the patient. The healthcare provider may set up various criteria to determine whether follow-up care is of interest, including, but not limited to: the condition discharged for, whether a prescription is part of the follow-up care, what medication has been prescribed (including name and dosage), how long the follow-up care is expected to last, and what party is responsible for the patient's follow-up care (e.g., the patient or a different healthcare provider). When it is determined that the follow-up care is of interest at DECISION OPERATION 320, method 300 proceeds to OPERATION 330. Otherwise, method 300 concludes.

At OPERATION 330, prescription information is extracted from the CCD. Prescription information includes, but is not limited to: the name of the medication prescribed, the dosage of the medication prescribed, quantity of the medication prescribed, the date of the CCD, quantity of the medication currently available to the patient, means of administering the medication, expiration date of the prescription, number of refills available, whether the medication is taken “as needed,” and identification information for the patient. In various aspects, this information may be extracted by an adherence engine 130 or may be sent pre-extracted to an adherence engine 130.

At OPERATION 340, filling information is retrieved for the patient's prescription. In various aspects, an adherence engine 130 queries a pharmacy database 140 for the filling information, while in other aspects the filling information may be provided to the adherence engine 130 by pharmacies in response to filling a prescription. When no filling information is retrieved at OPERATION 340, method 300 is operable to use the lack of filling information (e.g., null filling information) as the filling information. For example, if a patient does not fill a prescription, a pharmacy or pharmacy database 140 would not have a record of filling the prescription, which will be treated as a record of not filling the prescription (or fill information indicating that no medication at no dosage was filled to date).

The prescription information and filling information are compared at OPERATION 350. In various aspects, comparing the prescription information to the filling information includes determining whether the medication provided to the patient is the same or equivalent to that prescribed to the patient, whether the dosage is the same or equivalent to that prescribed to the patient, and whether the prescription was filled at or before the fill-by date.

At DECISION OPERATION 360, it is determined whether the comparison of the prescription information to the filling information indicates whether the patient is adhering to the course of treatment or deviating from the course of treatment. If the patient is currently adhering to the course of treatment, method 300 may conclude. If the patient is currently not adhering (i.e., is deviating) from the course of treatment, method 300 proceeds to OPERATION 370. As will be understood, if the patient has multiple refills of a prescription as part of a course of treatment, the method 300 may repeat OPERATIONS 340, 350, and 360 when the refill prescription's fill-by date occurs, which will result in a new determination of adherence or deviation at DECISION OPERATION 360.

At OPERATION 370, a healthcare provider alert is generated. In various aspects, because the CCD is compatible with the healthcare provider's electronic document system and contains information related to the visit (e.g., patient name, contact information, diagnosis, medication prescribed) that the healthcare provider can use to interpret the healthcare provider alert, the CCD from which the prescription information was extracted is used as a basis to build the healthcare provider alert. In other aspects, because of privacy concerns, the healthcare provider alert may be generated with a reduced subset of information from the CCD that excludes sensitive personal information related to the treatment of the patient. For example, a healthcare provider alert may include only enough information for the healthcare provider to be notified that a particular patient has deviated from a course of treatment. (e.g., a name or other personal identifier and a deviation flag).

The healthcare provider alert may be communicated to the healthcare provider according to various aspects. For example, the healthcare provider alert may be transmitted via email, text message (e.g., short message service, multimedia messaging service), pager service, or telephone to a healthcare professional 110. Alternatively, the healthcare provider alert may be held in a secure repository that a healthcare professional 110 may access via an internet-based portal service, and a prompt may be sent to the healthcare professional 110 to access the secure repository when a new healthcare provider alert is added to the repository. Additionally, the healthcare provider alert or a reminder may be automatically sent to the patient when a healthcare provider alert is generated. As will also be appreciated, the healthcare provider alert may be transmitted to (or accessed via a portal) by a healthcare professional 110 or organization other than the healthcare professional 110 or organization who discharged or prescribed the patient a given therapeutic, such as, for example, a health insurance provider for the patient, a medication monitor for the patient (e.g., a social worker, case manager, guardian or parole officer), or a second healthcare provider (e.g., a referring healthcare provider, a primary care healthcare provider, a family physician, a nursing or hospice facility).

Healthcare provider alerts may be organized in the secure repository for further analysis or may be deleted after a period of time when healthcare provider 110 has accessed the healthcare provider alert. The further analysis of the healthcare provider alerts may be used by healthcare providers to identify patients, healthcare professionals 110, and medications that have higher or lower rates of adherence, and take appropriate action. In various aspects, the analysis of healthcare provider alerts and deviation rates may be used to assign a risk assessment score to a given patient, healthcare professional 110, or medication. For example, a patient with a lower historical rate of adherence may be prescribed a home healthcare assistant (e.g., a visiting nurse), enrolled in a reminder program to ensure that medication is taken as prescribed, or assigned other additional or alternative treatment plans to better ensure that the patient adheres to the prescribed course of treatment. In another example, a healthcare professional 110 with a higher than average rate of patients adhering to their courses of treatment may be identified for study to determine best practices that healthcare professionals with lower than average rates are trained on. In yet another example, medicines (including dosages and means of administration) have their rates of adherence identified to inform healthcare professionals 110 of courses of treatment that their patients are more or less likely to deviate from.

Method 300 proceeds to OPTIONAL OPERATION 380, where the CCD is updated in the EMR database 120 to reflect how the patient is deviating from the course of treatment. In various aspects, a healthcare professional 110, upon reviewing the healthcare provider alert, determines whether OPTIONAL OPERATION 380 is performed; the deviation may be fixed by the healthcare professional 110 or not deemed important enough to record in the EMR database 120. For example, the patient may be called to remind the patient to fill the prescription or an alternative course of treatment may be substituted, and the prescription cancelled. The update to the CCD in the EMR database 120 may be used in conjunction with any analysis of historical data at the patient's next visit to a healthcare professional 110 (having received the healthcare provider alert or not) to properly address the ongoing treatment of the patient without relying on separate forms or adding to the CDA with custom documents. The healthcare professional 110 accessing the EMR of the patient will therefore know of the deviation and its extent so that corrective action (if needed) may be taken with knowledge of the patient's deviation from the original course of treatment. Method 300 then concludes.

FIG. 4 is a block diagram illustrating physical components of an example computing device 400 with which aspects of the present disclosure may be practiced. The computing device 400 may include at least one processing unit 402 and a system memory 404. The system memory 404 may comprise, but is not limited to, volatile (e.g. random access memory (RAM)), non-volatile (e.g. read-only memory (ROM)), flash memory, or any combination thereof. System memory 404 may include operating system 405, one or more program instructions 406, and may include an adherence engine 130 having sufficient computer-executable instructions, which when executed, perform functionalities as described herein. Operating system 405, for example, may be suitable for controlling the operation of computing device 400. Furthermore, aspects may be practiced in conjunction with a graphics library, other operating systems, or any other application program and is not limited to any particular application or system. This basic configuration is illustrated by those components within a dashed line 408. Computing device 400 may also include one or more input device(s) 412 (keyboard, mouse, pen, touch input device, etc.) and one or more output device(s) 414 (e.g., display, speakers, a printer, etc.).

The computing device 400 may also include additional data storage devices (removable or non-removable) such as, for example, magnetic disks, optical disks, or tape. Such additional storage is illustrated by a removable storage 409 and a non-removable storage 410. Computing device 400 may also contain a communication connection 416 that may allow computing device 400 to communicate with other computing devices 418, such as over a network in a distributed computing environment, for example, an intranet or the Internet. Communication connection 416 is one example of a communication medium, via which computer-readable transmission media (i.e., signals) may be propagated. In various aspects, the communication connection 416 may include an antenna for sending and receiving communications wirelessly according to various cellular (voice, data, and/or text) protocols and paging protocols.

Moreover, aspects may be practiced with other computer system configurations, including hand-held devices, multiprocessor systems, microprocessor-based or programmable user electronics, minicomputers, mainframe computers, and the like. Aspects may also be practiced in distributed computing environments where tasks are performed by remote processing devices that are linked through a communications network. In a distributed computing environment, program instructions 406 may be located in both local and remote memory storage devices.

Furthermore, aspects may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SoC)). Aspects may also be practiced using other technologies capable of performing logical operations such as, for example, AND, OR, and NOT, including, but not limited to, mechanical, optical, fluidic, and quantum technologies. In addition, aspects may be practiced within a general purpose computer or in any other circuits or systems.

Aspects may be implemented as a computer process (method), a computing system, or as an article of manufacture, such as a computer program product or computer-readable storage medium. The computer program product may be a computer storage medium readable by a computer system and encoding a computer program of instructions for executing a computer process. Accordingly, hardware or software (including firmware, resident software, micro-code, etc.) may provide aspects discussed herein. Aspects may take the form of a computer program product on a computer-usable or computer-readable storage medium having computer-usable or computer-readable program code embodied in the medium for use by, or in connection with, an instruction execution system.

Although aspects have been described as being associated with data stored in memory and other storage mediums, data can also be stored on or read from other types of computer-readable media, such as secondary storage devices, like hard disks, floppy disks, or a CD-ROM, or other forms of RAM or ROM. The term computer-readable storage medium refers only to devices and articles of manufacture that store data or computer-executable instructions readable by a computing device. The term computer-readable storage media do not include computer-readable transmission media.

Aspects of the present disclosure may be used in various distributed computing environments where tasks are performed by remote processing devices that are linked through a communications network.

Aspects of the present disclosure may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented with computing device 400 or any other computing devices 418, in combination with computing device 400, wherein functionality may be brought together over a network in a distributed computing environment, for example, an intranet or the Internet, to perform the functions as described herein. The systems, devices, and processors described herein are provided as examples; however, other systems, devices, and processors may comprise the aforementioned memory storage and processing unit, consistent with the described aspects.

The description and illustration of one or more aspects provided in this application are intended to provide a thorough and complete disclosure the full scope of the subject matter to those skilled in the art and are not intended to limit or restrict the scope of the present disclosure as claimed in any way. The aspects, examples, and details provided in this application are considered sufficient to convey possession and enable those skilled in the art to practice the best mode of the present disclosure as claimed. Descriptions of structures, resources, operations, and acts considered well-known to those skilled in the art may be brief or omitted to avoid obscuring lesser known or unique aspects of the subject matter of this application. The present disclosure should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept provided in this application that do not depart from the broader scope of the present disclosure as claimed.

We claim:

1. A method for the improved identification of non-adherence to a prescribed course of medication, comprising:
providing an adherence engine to a healthcare provider for installation on a computer device including a processor and memory storage device including instructions, which when execute by the processor enable the adherence engine to:
receive a continuity of care document (CCD) related to a patient sent from an Electronic Medical Records (EMR) database;
extract prescription information from the CCD;
receive filling information for the patient related to the prescription information from a pharmacy database;
compare the filling information to the prescription information to determine whether the filling information and the prescription information match;
when the filling information and the prescription information do not match:
calculating deviation information to generate a healthcare provider alert from the deviation information;
storing the healthcare provider alert; and
transmitting a message via a communication manager to a device associated with the healthcare provider, wherein the message includes a hyperlink to the healthcare provider alert stored by the adherence engine.

2. The method of claim 1, wherein if the filling information and the prescription information to not initially match based on not naming identical medications:
querying an equivalency database for equivalent compounds to medications indicated in the filling information and the prescription information to determine whether the filling information and the prescription information match but indicate different names for a given medication; and
when it is determined that the filling information and the prescription information indicate different names for the given medication, determining that the filling information matches the prescription information.

3. The method of claim 1, wherein if the filling information and the prescription information to not initially match based on not indicating identical dosages for a medication:
querying a metabolism rate database to determine whether a filled dosage is metabolically equivalent to a prescribed dosage; and
when it is determined that the filled dosage is metabolically equivalent to the prescribed dosage, determining that the filling information matches the prescription information.

4. The method of claim 1, wherein the CCD is received in response to a CCD pull request sent by the adherence engine to the EMR database.

5. The method of claim 4, wherein the CCD pull request is generated in response to receiving the fill information from the pharmacy database as a push from the pharmacy database.

6. The method of claim 1, wherein the filling information is received in response to a filling pull request sent by the adherence engine to the pharmacy database.

7. The method of claim 6, wherein the filling pull request is generated in response to receiving the CCD from the EMR database as a push from the EMR database.

8. The method of claim 1, wherein the filling information is null, indicating that the patient has not filled the prescription.

9. The method of claim 1, wherein prescription information includes a fill-by date and wherein comparing the filling information to the prescription information to determine whether the filling information and the prescription information match includes comparing a date that the filling information was generated to the fill-by date.

10. The method of claim 9, wherein the fill-by date is for a loosely scheduled medication, based on a date of a previous fill for the loosely scheduled medication for the patient, the amount of the loosely scheduled medication previously provided by the pharmacy to the patient, and a historic consumption rate of the loosely scheduled medication.

11. A system for the improved identification of non-adherence to a prescribed course of medication, comprising:
an adherence engine, operable to compare prescription information, indicating the prescribed course of medication, against filling information, indicating medications received by a patient, to determine whether the medications received match the prescribed course of medication, and to generate a healthcare provider alert when it is determined that the medications received do not match the prescribed course of medication, the adherence engine including:
an equivalency database, including listings of equivalent compounds for the medications received by the patient, wherein the listings are used by the adherence engine to compare against the prescription information in addition to the medications indicated by the filling information;
a metabolism rate database, including metabolism rate information for medications received by the patient, wherein the metabolism rates are used by the adherence engine to compare against the prescription information in addition to the medications indicated by the filling information;
a communications manager, operable to transmit a message to an operator to indicate that the healthcare provider alert has been generated; and
a portal server, operable to provide a user interface by which the operator accesses the healthcare provider alert.

12. The system of claim 11, wherein the adherence engine pulls the prescription information from an Electronic Medical Records database in response to receiving the filling information from a pharmacy database.

13. The system of claim 11, wherein the adherence engine pulls the filling information from a pharmacy database in response to receiving the prescription information from an Electronic Medical Records database.

14. The system of claim 11, wherein the prescription information includes a fill-by date after which it is determined that the medications received do not match the prescribed course of medication.

15. The system of claim 11, wherein the user interface enables the operator to browse healthcare provider alerts based on patient, medication, and healthcare professional.

16. A method for the improved identification of non-adherence to a prescribed course of medication, comprising:
generating a continuity of care document (CCD) associated with a patient at the discharge of the patient from a healthcare provider, wherein the continuity of care document includes a human readable component and a coded component, wherein the coded component is automatically generated from content entered into the human readable component;
analyzing the continuity of care document to determine whether the patient was discharged with an ongoing condition;
when it is determined that the patient was discharged with an ongoing condition:
extracting prescription information from the continuity of care document, the prescription information including a date of issue, a medication name, a medication dosage, a medication frequency, and a refill policy for a prescription;
analyzing the prescription information to determine a fill-by date;
querying a pharmacy database for filling information associated with the prescription;
comparing the prescription information with the filling information to determine whether the patient has filled the prescription by the fill-by date; and
when it is determined that the patient has not filled the prescription by the fill-by date, generating a healthcare provider alert, including deviation information, and updating the content of the human readable component of the continuity of care document to include the deviation information.

17. The method of claim 16, wherein updating the content of the human readable component bypasses the automatic generation of content in the coded component.

18. The method of claim 16, wherein the fill-by date is for a loosely scheduled medication and is based on historic fill rates for the loosely scheduled medication.

19. The method of claim 16, wherein the determination of whether the patient has filled the prescription by the fill-by date is used to update a risk assessment score for the patient.

20. The method of claim 16, wherein the healthcare provider alert is transmitted to an entity other than the healthcare provider from which the patient was discharged, wherein the entity is one of:
an insurance provider;
a medication monitor; or
a second healthcare provider.
